(19) United States
(12) Patent Application Publication
(10) Pub. No.: US 2014/0180872 A1
(43) Pub. Date: Jun. 26, 2014

(54) PURCHASE SUMMARY THROUGH EMAIL SCAN SYSTEMS AND METHODS

(71) Applicants: Ron Gura, Tel Aviv, IL (US); Matanya Bar, Tel Aviv, IL (US); Erez Dickman, Tel Aviv, IL (US)

(72) Inventors: Ron Gura, Tel Aviv, IL (US); Matanya Bar, Tel Aviv, IL (US); Erez Dickman, Tel Aviv, IL (US)

(21) Appl. No.: 13/899,462

(22) Filed: May 21, 2013

Related U.S. Application Data
(60) Provisional application No. 61/745,369, filed on Dec. 21, 2012.

(51) Int. Cl. G06Q 30/06

(52) U.S. Cl. CPC G06Q 30/0641
USPC 705/26.43; 705/27.1; 705/26.7

(57) ABSTRACT

Systems and methods for a purchase summary through email scan are described. The methods include accessing an email for a user, wherein the email includes a transaction history corresponding to a purchased item from a merchant, determining item and sales information from the transaction history, and updating a purchase summary display corresponding to the user with the item and sales information, wherein the purchase summary display includes account information corresponding to a plurality of items. The account information may include at least one of a total number of items purchased by the user, a total money spent by the user, a number of different categories of purchase by the user, and a number of different merchants purchased from by the user. Additionally, the purchase summary display may be used to offer additional items, engage in price matching, and/or sell purchased items.

### CROSS REFERENCE TO RELATED APPLICATION

The present application is related to and claims priority to U.S. Provisional Patent Application No. 61/745,369 filed Dec. 21, 2012, which is incorporated by reference in its entirety.

### BACKGROUND

1. Technical Field

The present application generally relates to electronic commerce and more specifically to systems and methods for a purchase summary through an email scan.

2. Related Art

Consumers make many purchases electronically, either through online sites or mobile applications. It can be difficult for consumers to organize or see summaries of their purchases, since payments may be through different funding sources and merchants. Even compiled together, such summaries may be difficult to understand or may not be very useful. An example is a year-end credit card summary statement that includes a breakdown of types of purchases made by the user with the credit card. While the user can see a summary, such as a listing or pie chart of expenditures, this may not be inclusive of all purchases made by the user during the year and may not provide much value. For example, purchases using other funding sources may not be provided, and breakdowns showing categories of expenditures, items purchased, and other analytics may not be displayed.

### BRIEF DESCRIPTION OF THE DRAWINGS

FIG. 1 is an illustration of a system environment used to provide a purchase summary through an email scan, according to one embodiment;

FIG. 2 is a flowchart of a process providing a purchase summary through an email scan according to one embodiment;

FIG. 3 is a flowchart of different processes accessible to a user utilizing a purchase summary according to embodiments of the present disclosure;

FIG. 4 is an exemplary purchase display summary according to one embodiment of the present disclosure;

FIG. 5 is an example of a purchased item page in a purchase summary display, according to one embodiment; and

FIG. 6 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is increasingly common for consumers to be provided with electronic receipts and transaction histories in an email account associated with the user. Often, in online transactions, this is the only form of receipt provided to a user. However, with no comparison between purchased items, or any crossover and linking between receipts, users do not have meaningful summaries of expenditures. Additionally, receipts offer little, if any, information concerning similar products or the same product offered by other merchants. Receipts do little to assist customers in taking advantage of retailer offers, such as price matching, or in finding items similar to recently purchased items.

The present disclosure provides systems and methods for generating and providing a purchase summary through an email scan. A consumer may engage in a series of online and/or offline purchases for items, where the purchases may generate an electronic receipt containing a transaction history. Items may refer herein to products, goods, and/or services, including digital goods. The consumer may opt to transmit this electronic receipt to an email account corresponding to a user device email client, such as MICROSOFT OUTLOOK®, or a web-based email client, such as GOGGLE GMAIL® and YAHOO! MAIL®. In embodiments of the present disclosure, the consumer may grant a service provider access to the email account. With access to the email account, the service provider may scan the email account to find emails with a transaction history. The service provider may access these emails and pull relevant item and sales information for use in updating a purchase summary display corresponding to the consumer. The purchase summary display may include account information for a plurality of items, such as total items purchased, money spent, item categories, and merchants of interest. Thus, the consumer is able see analytics of their transaction histories in an easy and accessible format without having to actively transmit or communicate transaction/purchase information.

In one embodiment, at least one user email account is scanned to obtain information about purchases made via that email address. An interface is then provided that shows purchases made by month, type, merchant, etc. The user may specify the type of display in one embodiment. Thus, receipts from emails can be stored and located in an easy to use interface. Furthermore, the user may be notified when a merchant offers a recent purchase at a lower price so that the user can take advantage of a price match if available. In other embodiments, the user may be able to relist or sell products, or receive offers for similar products to recent purchases.

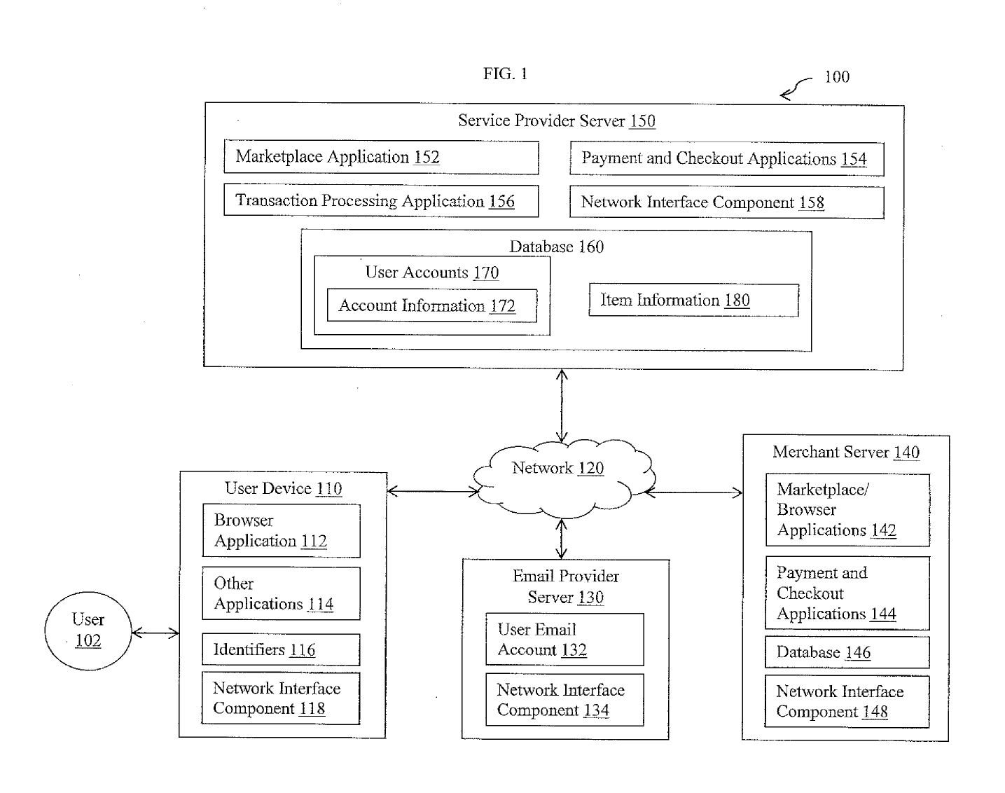

FIG. 1 is an illustration of a system environment used to provide a purchase summary through an email scan, according to one embodiment. As shown, system environment 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

FIG. 1 is a block diagram of networked system environment 100 configured to handle processes in accordance with embodiments provided herein. System environment 100 includes a user device 110, an email provider server 130, a merchant server 140, and a service provider server 150 in communication over a network 120. A user 102, such as a consumer, utilizes user device 110 to make a purchase transaction with one or more merchants. The transaction may be facilitated by service provider server 150 in certain embodiments. Service provider server 150 may be maintained by a service and/or payment provider, such as EBAY®, Inc. of San Jose, Calif. and PAYPAL®, Inc. of San Jose, Calif.

User device 110, email provider server 130, merchant server 140, and service provider server 150 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system environment 100, and/or accessible over network 120.

Network 120 may be implemented as a single network or a combination of multiple networks. For example, in various embodiments, network 120 may include the Internet or one or more intranets, landline networks, wireless networks, and/or other appropriate types of networks. Thus, network 120 may correspond to small scale communication networks, such as a private or local area network, or a larger scale network, such as a wide area network or the Internet, accessible by the various components of system environment 100.

User device 110 may be implemented using any appropriate hardware and software configured for wired and/or wireless communication over network 120. For example, in one embodiment, user device 110 may be implemented as a personal computer (PC), a smart phone, personal digital assistant (PDA), laptop computer, and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a browser application 112, other applications 114, a network interface component 116, and identifiers 118. Browser application 112 and other applications 114 may correspond to processes, procedures, and/or applications executable by a hardware processor, for example, a software program. In other embodiments, user device 110 may include additional or different software as required.

Browser application 112 may be used, for example, to provide a convenient interface to permit user 102 to browse information available over network 120. For example, in one embodiment, browser application 112 may be implemented as a web browser configured to view information available over the Internet or access a website of a service provider. Browser application 112 may be utilized access marketplace websites and engage in online transactions. Additionally, browser application 112 may access websites corresponding to web-based email clients.

In various embodiments, user device 110 includes other applications 114 as may be desired in particular embodiments to provide desired features to user device 110. For example, other applications 114 may include security applications for implementing client-side security features, programmatic client applications for interfacing with appropriate application programming interfaces (APIs) over network 120, or other types of applications. Other applications 114 may include an email client storing received emails. Other applications 114 may also include email, texting, voice and IM applications that allow user 102 to send and receive emails, calls, texts, and other notifications through network 120, as well as applications that enable the user to give access to the service provider of user emails as discussed above. Other applications 114 may contain software programs, such as a graphical user interface (GUI), executable by a processor that is configured to provide an interface to a user.

User device 110 may further include one or more identifiers 116 which may be implemented, for example, as operating system registry entries, cookies associated with browser application 112, identifiers associated with hardware of user device 110, or other appropriate identifiers, such as identifiers used for payment/user/device authentication or identification. In one embodiment, identifiers 116 may be used by a service provider, such as service provider server 150, to associate user 102 with a particular account maintained by the service provider.

In various embodiments, user device 110 includes at least one network interface component (NIC) 116 adapted to communicate with network 120 including email provider server 130, merchant server 140, and/or service provider server 150. In various embodiments, network interface component 116 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Moving to email provider server 130, email provider server 130 may be maintained, for example, by an email account provider, which may provide a user email account 132 to user 102. Generally, email provider server 130 may be maintained by any entity that provides and services email accounts to users, such as user 102. In this regard, email provider server 130 may include a web-based email client accessible to user 102 utilizing browser application 112 of user device 110. However, in other embodiments, email provider server 130 maintains user email account 132 for use with a locally available email client on user device 110. User email account 132 corresponds generally to an email address and mailbox for exchange of emails.

In various embodiments, email provider server 130 includes at least one network interface component (NIC) 134 adapted to communicate with network 120 including user device 110, merchant server 140, and/or service provider server 150. In various embodiments, network interface component 134 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant server 140 may be maintained, for example, by a merchant or seller offering various items, products, and/or services through an online site or application. Generally, merchant server 140 may be maintained by anyone or any entity that receives money, which includes charities as well as retailers and restaurants. In this regard, merchant server 140 may include marketplace/browser applications 142, which may be configured to interact with user device 110 and/or service provider server 150 to facilitate the sale of products, goods, and/or services. Additionally, merchant server 140 may include payment and checkout applications 144 to facilitate the exchange of money and the transmission of transaction histories to the purchaser.

Merchant server 140 may include marketplace/browser applications 142, which may be configured to serve information over network 120 to user device 110 and/or service provider server 150. In one embodiment, user 102 may interact with marketplace/browser applications 142 to view various items available for purchase from the merchant. Thus, marketplace/browser applications 142 may include a marketplace interface displayable on user device 110. However, in other embodiments, marketplace/browser applications 142 may correspond to a browser or other internet access utility for use by merchant server 140 to transmit products, goods, and services to service provider server 150 for listing and/or sale. In such embodiments, merchant server 140 may utilize service provider server 150 as a marketplace utility.

Merchant server 140 may also include payment and checkout applications 144, which may be configured to facilitate the purchase by user 102 of items, such as products, goods, and/or services, identified by marketplace/browser applications 142. Payment and checkout applications 144 may be configured to accept payment information from or on behalf of user 102 directly, or through service provider server 150 over network 120. For example, payment and checkout applications 144 may receive and process a payment confirmation from service provider server 150, as well as transmit transaction information to service provider server 150 and receive information from service provider server 150 (e.g., a transaction ID). In other embodiments, payment and checkout applications 144 may be configured to accept payments directly, through using secure payment confirmation forms. Payment and checkout applications 144 may also be configured to accept one or more different funding sources for payment. Payment and checkout applications 144 may be further configured to transmit emails to a user email account with a transaction history.

Merchant server 140 includes a database 146 identifying available products, goods, and/or services (e.g., collectively referred to as items) which may be made available for viewing and purchase by user 102. Database 146 may include tracking numbers for the items, stock amounts, prices, and other item information.

In various embodiments, merchant server 140 includes at least one network interface component (NIC) 148 adapted to communicate with network 120 including user device 110, email provider server 130, and/or service provider server 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 150 may be maintained, for example, by a merchant service provider, such as EBAY®, Inc. of San Jose, Calif., and/or an online payment service provider, such as PAYPAL®, Inc. of San Jose, Calif., which may facilitate sales between user 102 and the operator of merchant server 140. In this regard, service provider server 150 may include one or more marketplace application 152, which may be configured to list, for payment or auction, items included in database 146 of merchant server 140. Service provider server 150 may be further configured to facilitate payment of items from merchant server 140. Thus, service provider server 150 may include payment and checkout applications 154, which may be configured to interact with user device 110 and merchant server 140 over network 120 to facilitate the purchase of goods or services by user 102 of user device 110.

Service provider server 150 may include marketplace application 152, which may be configured to serve information over network 120 to user device 110 and/or merchant server 140. In one embodiment, user 102 may interact with marketplace application 152 to view various items available for purchase from the merchant. Thus, marketplace application 152 may include a marketplace interface displayable on user device 110. Marketplace application 152 may correspond to the same or a similar marketplace contained in marketplace/browser application 142 of merchant server 140, for example, in embodiments where service provider server 150 hosts marketplace application 152 for use by an operator of merchant server 140. However, in other embodiments, marketplace server 152 may refer to a separate marketplace interface with listed items from database 146 of merchant server 140 and/or separate items from further merchants.

In certain embodiments, merchant server 140 also includes payment and checkout applications 154, which may be configured to facilitate the purchase by user 102 of items, such as products, goods, and/or services, identified by marketplace application 152. Payment and checkout applications 154 may be configured to accept payment information from or on behalf of user 102. For example, payment and checkout applications 154 may receive and process a payment from user 102, as well as transmit transaction information to merchant server 140 and receive information from merchant server 140 (e.g., am item and/or transaction ID). Payment and checkout applications 154 may also be configured to accept one or more different funding sources for payment. Payment and checkout applications 154 may be further configured to transmit emails to a user email account with a transaction history.

Transaction processing application 156, which may be part of payment and checkout applications 154 or separate, may be configured to receive information from user device 110 and/or merchant server 140 for processing and storage in a database 160. Transaction processing application 156 may include one or more applications to process information from user 102 and/or merchant server 140 such as a transaction history from user emails as described herein. As such, transaction processing application 154 may store details of a transaction history from an email and associate the details accordingly for individual users. Transaction processing application 156 and/or payment and checkout application 154 may be further configured to determine the existence of and to manage accounts, such as one of user accounts 170, for user 102, as well as create new accounts if necessary, such as the set-up, management, and provide various services as described herein. Transaction processing application 156 may further containing processes, applications, and/or software to transmit, render, and/or display an interface to a user. The interface may correspond to a purchase summary display including information collected and analyzed from scanned and accessed emails, as described herein.

Additionally, service provider server 150 may include database 160 having user accounts 170 with account information 172 and item information 180. Database 160 may correspond to a data collection stored in a memory of service provider server 150. Service provider server 150 may maintain a plurality of user accounts 170, each of which may include account information 172 associated with individual users. For example, account information 172 may include private financial information of users of devices such as account numbers, passwords, device identifiers, user names, phone numbers, credit card information, bank information, or other financial information which may be used to facilitate online transactions by user 102. Account information 172 may also include information associated with the transaction history processing described herein. Advantageously, payment and checkout applications 154 may be configured to interact with merchant server 140 on behalf of user 102 during a transaction with payment and checkout applications 144 to handle payments using account information 172 corresponding to user 102.

Database 160 may further contain item information 180. Item information 180 may correspond to product, goods, and/or services information compiled across a plurality of merchants using transaction processing application 156. Item information 180 may be utilized to recall lower sales offers for price matching, find similar items to offer like sales, and provide user 102 with additional item data. Item information 180 may be further utilized to populate information fields when user 102 requests to sell an item. For example, item information 180 may include price averages, descriptions, listing titles, and/or other item information necessary to populate item listing information fields, for example using a sales listing with marketplace application 152.

In various embodiments, service provider server 150 includes at least one network interface component (NIC) 158 adapted to communicate with network 120 including user device 110, email service provider 130, and/or merchant server 140. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

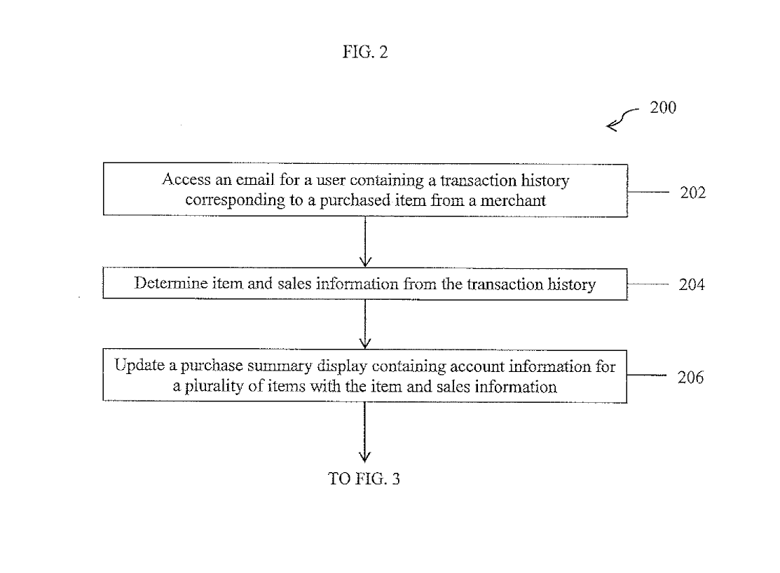

FIG. 2 is a flowchart of a process providing a purchase summary through an email scan according to one embodiment. Note that one or more steps, processes, and methods described herein may be omitted, performed in a different sequence, or combined as desired or appropriate.

At step 202 of method flowchart 200, a service provider, such as EBAY® and/or PAYPAL®, scans an email for a user, where the email contains a transaction history corresponding to a purchased item from a merchant. A user, such as user 102, may previously give permission to service provider server 150 to scan a plurality of emails. In certain embodiments, the user may specify where and which emails may be scanned. The user may give access to scan all or part of an email client located on user device 110, such as a MICROSOFT OUTLOOK® client. In another embodiment, the user may give permission or access to a web-based email client, such as email provider server 130, to access and scan all or part the stored emails. Still in other embodiments, the user may specify user email account 132 and allow a scan of all or part of the associated email clients and mailboxes.

Transaction processing application 156 may scan the plurality of user's emails to determine emails that contain a transaction history. The emails that contain a transaction history may be email addresses the user uses to make purchases. When the user makes a purchase, the merchant may know the user's email address to send a purchase confirmation and receipt. Once the transaction processing application has determined an email that contains a transaction history, the application may access or process the email.

Once the transaction processing application of the service provider server accesses an email containing a transaction history, the application may determine item and sales information from the transaction history, at step 204. The transaction processing application may obtain various information from the email, including what may be in any email attachments. The service provider may determine a merchant name, the purchased item(s), the price, the type of item(s), the date of purchase, funding source, warranty information, receipt, etc. Item types for categorization may include books, tools and home improvement, software and mobile applications, shoes, movies and TV, jewelry and watches, automotive, travel and entertainment, music, sports and outdoors, toys and games, health and beauty, home and kitchen, apparel and accessories, payments, electronics and accessories, grocery and gourmet food, gift cards, office products, tickets and events, baby products, online services, deals and offers, pet supplies, flowers and gifts, appliances, magazines, and photos and paper products, although such a list is not limiting. If a purchase does not fit into an existing category, a new category may be created or put into a miscellaneous category.

Next, at step 206, a purchase summary display containing account information for a plurality of items is updated with the item and sales information. For example, the purchase may be added to the account information, which would increase the total amount spent by the user for the month and the year, increase a purchase number in a particular category or with a particular merchant, etc. The purchase summary display may include a viewable layout containing these analytics. The display may further include additional data, such as user demographics corresponding to items, item sales histories, and other data. The purchase summary display may be updated with new information corresponding to each new scanned email. Note that an email may also be for a return or refund, in which case, the account would be updated with corresponding decreases based on the removal of a previously purchased item.

The service provider server may provide the purchase summary display to the user, for example through a user device. The purchase summary display may include the current or updated summary of the user's purchases made through one or more of the user's email accounts. Thus, purchases from different merchants and/or different funding sources may all be included in the purchase summary display. The purchase summary display may include the total number of items purchase, the total money spent, the number of different categories of purchase, the number of different merchants purchased from, etc. The user may adjust the period for the purchase summary display, for example, the display may be for the year to date, the current month, the trailing twelve months, or any other period. The user may see the various data for a specific merchant, category, time period, etc.

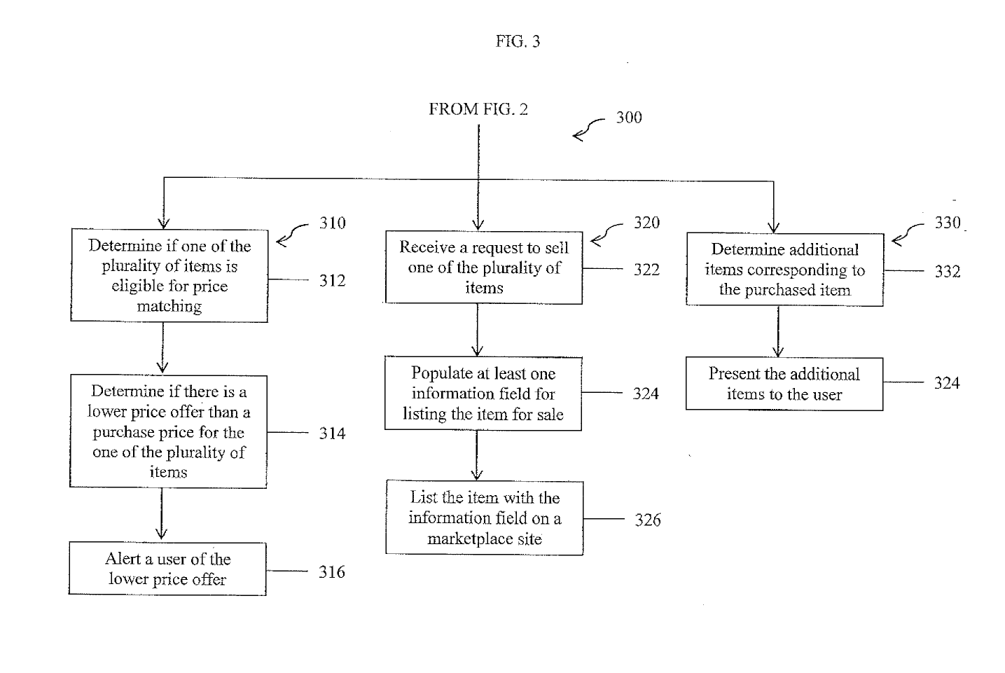

FIG. 3 is a flowchart of different processes accessible to a user utilizing a purchase summary according to embodiments of the present disclosure. Continuing from FIG. 2, the method of flowchart 300 may proceed with a process 310, a process 320, and/or a process 330. However, it is understood that each of processes 310, 320, 330 and the steps, processes, and methods described herein may be omitted, performed in a different sequence, or combined as desired or appropriate.

At step 312 of process 310, a service provider server, such as service provider server 150, determines if one of the plurality of items of the purchase summary display is eligible for price matching. Price matching may include a merchant guarantee, given to a consumer when an item is purchased, that the merchant's price at purchase will be the lowest for the item. Thus, if a lower price is offered by another merchant or the same merchant within a certain time after purchase, the merchant will refund the difference to the consumer and/or be willing to refund the purchase cost in exchange for the item. Thus, at step 312, the service provider may determine whether the merchant is one who offers price matching, and if so, whether the current purchase is eligible for price matching.

The service provider may determine if the merchant, such as one associated with merchant server 140, offers price matching through item and sales information taken from the previously scanned email. If the email guarantees a price match by the merchant for the item, then the service provider server may continue to step 114. Additionally, the service provider may further request information from the merchant or search the merchant server for price matching guarantees. The service provider may further note the purchase date and when the price matching feature ends, such as two weeks after purchase or another time after purchase. Information received from searching merchants may be stored as item information 180 with additional item information for future use.

If the merchant does offer price matching on specific items, the service provider server may further search for matching items to the user's item(s). At step 314, the service provider may search for merchants selling the item to determine whether a lower price is being offered for the item. Transaction processing application 156 may utilize a search function to search other merchant sites for the same product. Item information searched and retrieved may be stored in item information 180. Additionally, the transaction processing application may utilize item information 180 previously stored to find matching products and prices.

If a lower price offer is found, at step 316, the user may be alerted of the lower price offer. The alert may include an email, text message, purchase summary display icon, or other notification viewable by the user. The alert may also be communicated by voice to the user device. The alert may further include additional data and/or information, such as the name of the merchant offering the item and the price, a link to the merchant offering, time remaining to utilize the price match, and/or other data. Once received, the user may notify the selling merchant and supply any information needed so that the merchant can honor the price matching, including sending a screen shot or link of the merchant offering the lower price. Additionally, the purchase summary display may be configured to contact the merchant and present the information on behalf of the user, such as by sending the screen shot.

In another embodiment, the service provider may provide an easy way for a user to sell an item the user has purchased. In process 320 of flowchart 300, the user may select a purchased item and send a request to sell that item, such as on EBAY® or other marketplace site. A request to sell one of the plurality of items is received by a service provider, at step 322. The request may be sent from a user device, such as user device 110 corresponding to a personal computer, smart phone, computing tablet, or other device. The user may select an option to sell or list a selected item from the user's purchased items in the purchase summary display. In certain embodiments, the user may view a link or select a box to initiate the sales request. Once the item is selected, at least one information field may be displayed, where listing information, such as item, pricing, listing time, and/or other information may be entered.

Next, at step 324, the service provider may populate at least one information field necessary to list the item for sale. Service provider server 150 may have received details of the item, such as the item name, when the item was purchased, where the item was purchased, the price, the description etc., from the email scan. Additionally, the service provider may have received additional information corresponding to the item when searching merchant servers in process 310. The service provider may have stored the information as item information 180. Additionally, using item information 180 and/or searches of merchants, the service provider can compare the item with other similar items listed for sale. The service provider can use this information to fill out one or more fields of a sales listing for the user. For example, a description may be filled in, and a “best” price, based on recent completed sales of the same or comparable item may be inserted. The sales listing may include information fields such as the item name, price, location of item, item description, etc., and can be for a fixed price listing or an auction listing.

Once fields are populated, the user may be presented with the listing to approve, edit, or cancel. The user may change data in one or more fields or areas, such as price, description, etc. Once the user is satisfied with the listing, the user may approve the listing for the service provider to post the item and the information field(s), at step 326, on the service provider site or other marketplace site. This allows the user a quick and easy way to list an item the user has purchased.

In other embodiments, the service provider may use information from the user email and/or searched merchants to provide additional products, goods, and/or services to the user. For example, the method of flowchart 300 continues with process 330 showing a service provider searching for items relevant to the purchased item, such as accessories. At step 332, service provider server 150 may determine additional items corresponding to the purchased item. For example, the user email may indicate that the user has placed a certain item on hold or in a cart, but has not purchased the item. The service provider may then search for merchants offering the item at a lower price and provide that information to the user. In another example, the service provider may use searched merchant information, such as item information 180, to offer similar items in an item category, or find items other users purchased along with the purchased item. The service provider may then provide suggestions, offers, or incentives on such additional items to purchase, including links or other information on how to purchase those items.

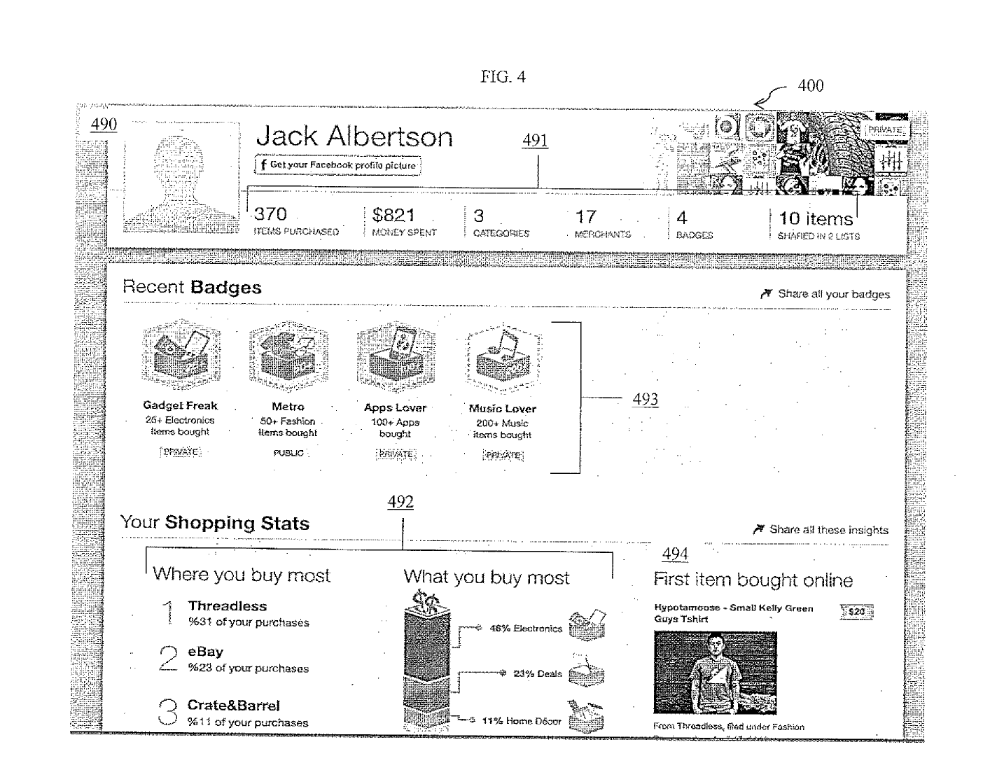

Moving to FIG. 4, FIG. 4 is an exemplary purchase display summary according to one embodiment of the present disclosure. FIG. 4 presents a purchase display summary created from user email scans. The purchase display summary may be presented to a user through browser application 112 of user device 110. For example, user 102 may utilize user device 110 to access the internet and look up websites using browser application 112. In some embodiments, a software program may be downloaded or otherwise installed on the user device that may present a purchase summary display.

A purchase summary display 400 of FIG. 4 includes a user profile 490 containing a purchase summary 491, analytics 492, consumer engagements 493, and purchased item 494. Although purchase summary display 400 is shown with the aforementioned features, it is understood other embodiment of a purchase summary display may include additional and/or other features.

User profile 490 may include user account and user information taken from user accounts 170 and account information 172. As shown in FIG. 4, user profile 490 includes a user account name, photograph, and a link to sharing a social networking profile. User profile 490 may include further information and options, such as a “private” account setting, background and layout settings, additional information taken from account information 172, and/or other desired options.

Purchase summary display 400 may further include purchase summary 491 shown with a breakdown of purchases and corresponding purchase data. Purchase summary 491 is shown with data corresponding to items purchases, total money spent, categories of purchases, merchants used, customer engagements earned, and shared items. This summary data may be collected from user email scans as previously discussed. A service provider may aggregate this data and present it to the user along with other data determined by the service provider. For example, in addition to accruing a total items purchased and money spent from accessing user emails, the service provider may also split the items into item categories for easier sorting by the user. The service provider may include a list of merchants used so the user may more easily find users with products the user is interested in. Additionally, the service provider can create and distribute consumer engagements, such as badges, icons, coupons, or other enticements to encourage user purchases and sales. These may be accrued by a user and a total displayed in the purchase summary. Additionally, the user may engage in user interactions, such as shared user lists and other social networking interactions.

In various embodiments, purchase summary display 400 may provide the user with analytics 492. Analytics may correspond to purchase breakdowns including types of purchased products, money spend on types of products, merchant use, money spent to each merchant used, and/or other data from processing user emails.

Purchase summary display 400 may include consumer engagements 493 in certain embodiments. As previously discussed, consumer engagements 493 may correspond to badges, icons, and other content. The content may be distributed to users as awards for consumer transactions. Additionally, the content may be awards to entice the user to engage in future transactions, through winning awards, earning points, or receiving coupons, for example.

Certain embodiments of purchase summary display 400 may include at least one purchased item 494. Purchased item 494 may include a link to the user email and/or user transaction corresponding to purchased item 494. In other embodiments, purchased item 494 may redirect the user to the selling merchant's item and/or homepage, or provide the user with other links. For example, certain embodiments may allow the user to link to a breakdown and/or data corresponding to purchased item 494 including future actions taken with respect to purchased item 494, such as relisting and selling purchased item 494, requesting a merchant price match, and/or finding related items to purchased item 494.

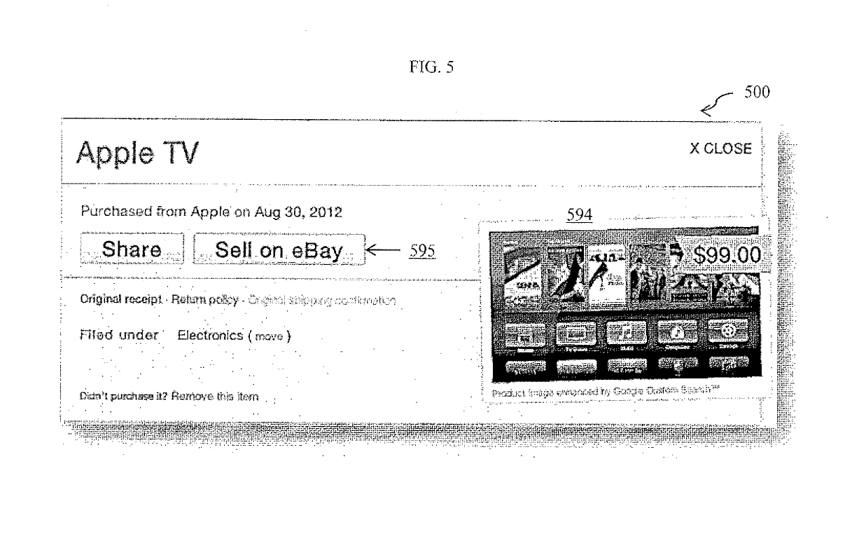

FIG. 5 is an example of a purchased item page in a purchase summary display, according to one embodiment. The purchased item page may be created using data from the user email scan and from service provider product information and merchant searches. The purchased item page may be retrieved through selecting a purchased item elsewhere in the purchase summary display. For example, in purchase summary display 400 of FIG. 4, purchased item 494 may be presented for user interaction. By selecting purchased item 494, the user may view the purchased item page.

A purchased item page 500 of FIG. 5 is shown with a purchased item 594 and a sell button 595. Although purchased item page 500 is shown with the aforementioned features, it is understood other embodiment of a purchase summary display may include additional or other features.

Purchased item 594 may correspond generally to purchased item 494, for example, by providing the user with links to a merchant and/or item, requesting price matches, and/or finding similar and/or related items. In other embodiments, purchased item 594 may provide separate data corresponding to the item, such as current sales prices, best time to sell the item, number and/or volume of product sales, and other data.

Purchase item page 500 may further include sell button 595, which may allow a user to list and sell purchased item 594. Sell button 595 may include processes to receive a request to sell purchased item 594, list purchased item 594 on a marketplace site, populate information fields on a marketplace site for purchased item 594, and/or other processes. The information fields may include a name and a price for purchased item 594, a description of purchased item 594, photographs of purchased item 594, and other relevant information. The service provider may utilize data in user account 172 and/or item information 180 to populate the information fields.

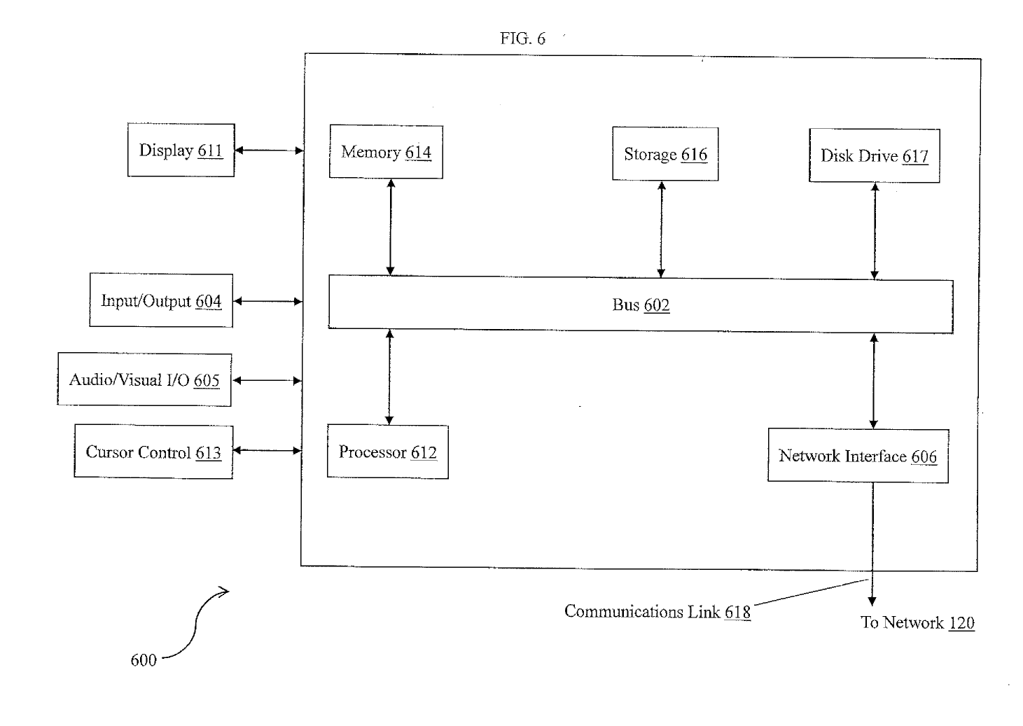

FIG. 6 is a block diagram of a computer system 600 suitable for implementing one or more embodiments of the present disclosure. In various embodiments, the user device may comprise a personal computing device (e.g., a personal computer, laptop, smart phone, tablet, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and service/payment providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons or links, etc., and sends a corresponding signal to bus 602. I/O component 604 may also include an output component, such as a display 611 and a cursor control 613 (such as a keyboard, keypad, mouse, etc.). One or more optional audio/video (A/V) input/output (I/O) components 605 may also be included to allow a user to use voice and/or video for inputting information by converting audio signals. A/V I/O component 605 may allow the user to hear audio. A transceiver or network interface 606 transmits and receives signals between computer system 600 and other devices, such as another user device, a merchant server, or a service/payment provider server via network 120. In one embodiment, the transmission is wireless, although other transmission mediums and methods may also be suitable. A processor 612, which can be a micro-controller, digital signal processor (DSP), or other processing component, processes these various signals, such as for display on computer system 600 or transmission to other devices via a communication link 618. Processor 612 may also control transmission of information, such as cookies or IP addresses, to other devices.

Components of computer system 600 also include a system memory component 614 (e.g., RAM), a static storage component 616 (e.g., ROM), and/or a disk drive 617 to store information, such as account information, transaction numbers, machine IDs, and other information described above. Computer system 600 performs specific operations by processor 612 and other components by executing one or more sequences of instructions contained in system memory component 614. Instructions may be performed by one or more processors 612. Logic may be encoded in a computer readable medium, which may refer to any medium that participates in providing instructions to processor 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more machine readable mediums, including non-transitory machine readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Embodiments described herein are exemplary only. One skilled in the art may recognize various alternative embodiments from those specifically disclosed. Those alternative embodiments are also intended to be within the scope of this disclosure. As such, the embodiments are limited only by the following claims.

What is claimed is:

1. A system comprising:
a memory storing a user account, wherein the user account includes one or more email addresses corresponding to a user; and
one or more hardware processors in communication with the memory, the one or more hardware processors configured to:
access an email for the user, wherein the email includes a transaction history corresponding to a purchased item from a merchant;
determine item and sales information from the transaction history; and
update a purchase summary display corresponding to the user with the item and sales information, wherein the purchase summary display includes account information corresponding to a plurality of items.

2. The system of claim 1, wherein the account information comprises at least one of a total number of items purchased by the user, a total money spent by the user, a number of different categories of purchase by the user, and a number of different merchants purchased from by the user.

3. The system of claim 1, wherein the purchase summary display includes an adjustable period set by the user.

4. The system of claim 1, wherein the one or more hardware processors are further configured to present an additional item corresponding to the purchased item to the user.

5. The system of claim 1, wherein the one or more hardware processors are further configured to:
determine if one of the plurality of items is eligible for price matching;
determine if there is a lower price offer than a purchase price for the one of the plurality of items; and
alert the user of the lower price offer.

6. The system of claim 1, wherein the one or more hardware processors are further configured to:
receive a request to sell one the of the plurality of items;
populate at least one information field for the one of the plurality of items; and
list the one of the plurality of items with the at least one information field on a merchant service site.

7. The system of claim 6, wherein the one or more hardware processors is further configured to automatically populate the at least one information field with a name and a price for the one of the plurality of items.

8. The system of claim 7, wherein the one or more hardware processors is further configured to automatically populate the at least one information field with a description for the one of the plurality of items.

9. A non-transitory machine-readable medium comprising a plurality of machine-readable instructions which when executed by one or more processors of a server are adapted to cause the server to perform a method comprising:
accessing an email for a user, wherein the email includes a transaction history corresponding to a purchased item from a merchant;
determining item and sales information from the transaction history; and
updating a purchase summary display corresponding to the user with the item and sales information, wherein the purchase summary display includes account information corresponding to a plurality of items.

10. The non-transitory machine-readable medium of claim 9, wherein the account information comprises at least one of a total number of items purchased by the user, a total money spent by the user, a number of different categories of purchase by the user, and a number of different merchants purchased from by the user.

11. The non-transitory machine-readable medium of claim 9, wherein the purchase summary display includes an adjustable period set by the user.

12. The non-transitory machine-readable medium of claim 9, wherein the one or more hardware processors are further configured to present an additional item corresponding to the purchased item to the user.

13. The non-transitory machine-readable medium of claim 9, wherein the method further comprises:
determining if one of the plurality of items is eligible for price matching;
determining if there is a lower price offer than a purchase price for the one of the plurality of items; and
alerting the user of the lower price offer.

14. The non-transitory machine-readable medium of claim 9, wherein the one or more hardware processors are further configured to:
receiving a request to sell one the of the plurality of items;
populating at least one information field for the one of the plurality of items; and
listing the one of the plurality of items with the at least one information field on a merchant service site.

15. The non-transitory machine-readable medium of claim 14, wherein the one or more hardware processors is further configured to automatically populate the at least one information field with a name and a price for the one of the plurality of items.

16. The non-transitory machine-readable medium of claim 15, wherein the one or more hardware processors is further configured to automatically populate the at least one information field with a description for the one of the plurality of items.

17. A method comprising:
accessing, by a hardware processor of a service provider server, an email for a user, wherein the email includes a transaction history corresponding to a purchased item from a merchant;
determining item and sales information from the transaction history; and
updating a purchase summary display corresponding to the user with the item and sales information, wherein the purchase summary display includes account information corresponding to a plurality of items.

18. The method of claim 17, wherein the account information comprises at least one of a total number of items purchased by the user, a total money spent by the user, a number of different categories of purchase by the user, and a number of different merchants purchased from by the user.

19. The method of claim 17, further comprising:
determining if one of the plurality of items is eligible for price matching;
determining if there is a lower price offer than a purchase price for the one of the plurality of items; and
alerting the user of the lower price offer.

20. The method of claim 17, further comprising:
receiving a request to sell one the of the plurality of items;
populating at least one information field for the one of the plurality of items; and
listing the one of the plurality of items with the at least one information field on a merchant service site.
